(19) United States
(12) Patent Application Publication
(10) Pub. No.: US 2012/0232792 A1
(43) Pub. Date: Sep. 13, 2012

(54) POSITIONING APPARATUS AND POSITIONING METHOD

(75) Inventors: Yimei Ding, Suwa-shi (JP); Shuji Uchida, Suwa-shi (JP)

(73) Assignee: SEIKO EPSON CORPORATION, Shinjuku-ku (JP)

(21) Appl. No.: 13/414,628

(22) Filed: Mar. 7, 2012

(30) Foreign Application Priority Data
Mar. 8, 2011 (JP) 2011-049917

(51) Int. Cl. G01S 19/49; G01C 21/00

(52) U.S. Cl. 701/472

(57) ABSTRACT

A positioning apparatus includes: a unit that calculates an inertial navigation positioning result by performing position calculation using inertial sensor data and stores the inertial navigation positioning result in a storage unit with time information being added to the inertial navigation positioning result; a unit that calculates a GPS positioning result by using GPS positioning data; a unit that performs a coupling process for the GPS positioning result and the inertial navigation positioning result, which is stored in the storage unit, having the same time information as time when the GPS positioning data is acquired; a unit that corrects the inertial navigation positioning result stored in the storage unit based on information of a position error, an attitude error, a velocity error, and a bias error of the inertial sensor that are acquired through the coupling process.

### BACKGROUND

1. Technical Field

The present invention relates to a positioning apparatus and a positioning method.

2. Related Art

In a case where high-precision positioning is performed indoor and outdoor by combining GPS positioning data and inertial sensor data, since a delay time with respect to the current time occurs in the GPS positioning data due to a transmission time and a position calculation time, time synchronization between the GPS positioning data and the inertial sensor data needs to be performed. As a method of synchronizing the GPS positioning data and the inertial sensor data, a method is known in which time acquired by subtracting a position calculation time and a transmission time from the time at which the GPS positioning data has arrived is set as GPS reference time, a detection result corresponding to the time that is closest to the reference time out of detection results of an inertial sensor is specified as detection data to be synchronized, a difference between the detection time of the specified detection result and the GPS reference time is calculated, and time synchronization between the GPS positioning data and the inertial sensor data is performed by propagating the calculated time difference (for example, JP-A-2009-222438).

In the positioning method disclosed in JP-A-2009-222438, in order to synchronize the positioning result of the inertial sensor and the GPS positioning result, a difference ΔTp between the detection time of the inertial sensor and the reference time of the GPS is calculated, a velocity vector of a moving body is multiplied by the time difference ΔTp so as to be integrated with the position of the moving body that is measured at a period i by using an extrapolation method (also called external interpolation), whereby the position of the moving body is corrected, and the corrected position is associated with the detection result of the sensor.

The interpolated position of the moving body can be represented by the following Equation.

$$( \begin{matrix}{X}_{u}^{′} ( i ) \\ {Y}_{u}^{′} ( i ) \\ {Z}_{u}^{′} ( i )\end{matrix} ) = ( \begin{matrix}{X}_{u} ( i ) \\ {Y}_{u} ( i ) \\ {Z}_{u} ( i )\end{matrix} ) + ( \begin{matrix}{v}_{x} ( i ) \\ {v}_{y} ( i ) \\ {v}_{z} ( i )\end{matrix} ) \cdot Δ {T}_{p} \qquad ( 1 )$$

According to such a synchronization method, in a case where the magnitude of the velocity is not maintained to be constant due to acceleration or deceleration of the moving body, or the direction of the velocity changes due to rotation, the position of the moving body, which is corrected by using the extrapolation method, may be deviated considerably from the real position of the moving body at the detection time. In addition, since it is difficult to extrapolate the velocity or the azimuth, there is a problem in that the GPS positioning result and the detection result of the inertial sensor are not synchronized to each other and are not correctly coupled.

### SUMMARY

An advantage of some aspects of the invention is to solve at least a part of the problems described above, and the invention can be realized as in the following forms or application examples.

### APPLICATION EXAMPLE 1

This Application Example is directed to a positioning apparatus including: a unit that calculates an inertial navigation positioning result by performing position calculation using inertial sensor data and stores the inertial navigation positioning result in a storage unit with time information being added to the inertial navigation positioning result; a unit that calculates a GPS positioning result by using GPS positioning data; a unit that performs a coupling process for the GPS positioning result and the inertial navigation positioning result, which is stored in the storage unit, having same time information as time when the GPS positioning data is acquired; a unit that corrects the inertial navigation positioning result stored in the storage unit based on information of a position error, an attitude error, a velocity error, and a bias error of the inertial sensor that are acquired through the coupling process.

According to this application example, simultaneously with the position calculation performed by the inertial sensor, the time information of a clock, the inertial sensor data, and the positioning result (the acceleration, the angular velocity, the position, the attitude, and the velocity) are buffered. Then, at a time point when the GPS positioning result is acquired, the time information of the GPS positioning result and the time information of the positioning result of the inertial sensor that is stored in a buffer are compared with each other, and the GPS positioning result and the positioning result of the inertial sensor that have the same time information are coupled so as to realize time synchronization. In addition, error correction is performed by feeding back the error information estimated through the coupling process to the buffered positioning result of the inertial sensor, whereby the error in the buffered integration result of the inertial sensor can be reduced without integrating the sensor data again by using correct error information. Furthermore, by performing error correction by feeding back the position error, the attitude error, the velocity error, and the bias error of the inertial sensor, which are estimated through coupling, to the positioning result of the inertial sensor at the current time, accurate positioning information at the current time can be provided.

### APPLICATION EXAMPLE 2

It is preferable that, in the positioning apparatus according to the above-described application example, the coupling process is a Karman filter process of the inertial navigation positioning result and the GPS positioning result.

Since the Karman filter is a technique for estimating the state of a system based on an established theory by using an external observation amount that changes from time to time, in such a case, a positioning result having higher accuracy can be acquired.

### APPLICATION EXAMPLE 3

It is preferable that, in the positioning apparatus according to the above-described application example, the unit that corrects the inertial navigation positioning result stored in the storage unit estimates the positioning error, the attitude error, the velocity error, and the bias error and correcting the inertial navigation positioning result based on the positioning error, the attitude error, the velocity error, and the bias error.

In such a case, since the correction is made by estimating the change in position after the GPS positioning data is acquired, a positioning result having higher accuracy can be acquired.

### APPLICATION EXAMPLE 4

It is preferable that, in the positioning apparatus according to the above-described application example, the position calculation using the inertial sensor data is performed more frequently than the GPS positioning using the GPS positioning data.

The position calculation using the GPS may require a time longer than that required for the position calculation using the inertial sensor, and accordingly, by supplementing the positioning with the positioning using the inertial sensor in the middle of calculation of the GPS positioning, a positioning result having higher accuracy can be acquired in such a case.

### APPLICATION EXAMPLE 5

It is preferable that, in the positioning apparatus according to the above-described application example, the inertial sensor data is data that is measured by at least one of an acceleration sensor and a gyro sensor.

In such a case, since the movement of the moving body is acquired by using at least one of the acceleration sensor and the gyro sensor, a positioning result having higher accuracy can be acquired.

### APPLICATION EXAMPLE 6

This application example is directed to a positioning method including: calculating an inertial navigation positioning result by performing position calculation using inertial sensor data and storing the inertial navigation positioning result in a storage unit with time information being added to the inertial navigation positioning result; calculating a GPS positioning result by using GPS positioning data; estimating a position error, an attitude error, a velocity error, and a bias error of the inertial sensor by coupling the GPS positioning result and the inertial navigation positioning result, which is stored in the storage unit, having the same time information as time when the GPS positioning data is acquired; correcting the inertial navigation positioning result stored in the storage unit based on the position error, the attitude error, the velocity error, and the bias error.

According to this application example, the inertial sensor data, the positioning result of the inertial sensor, and the time information are buffered, and the time information of the GPS positioning result and the time information of the inertial sensor data are synchronized to each other. In addition, the buffered positioning result of the inertial sensor can be corrected by feeding back the position error, the attitude error, the velocity error, and the bias error of the inertial sensor, which are estimated by coupling the positioning result of the inertial sensor and the GPS positioning result, which are synchronized to each other, to a buffering section of the inertial sensor. Accordingly, the past sensor data does not need to be integrated again by using the correct error information, and the calculation load can be decreased to a large extent. Furthermore, by performing error correction by feeding back the position error, the attitude error, the velocity error, and the bias error of the inertial sensor, which are estimated through coupling, to the positioning result of the inertial sensor at the current time, the moving body can be provided with accurate positioning information at the current time.

### BRIEF DESCRIPTION OF THE DRAWINGS

The invention will be described with reference to the accompanying drawings, wherein like numbers reference like elements.

FIG. 1 is a configuration block diagram showing an overview of a moving body control device.

FIG. 2 is a block diagram showing an overview of a calculation control unit.

FIG. 3 is a flowchart illustrating the main process of a method of positioning a moving body.

FIG. 4 is an explanatory diagram showing a synchronization processing method.

FIGS. 5A and 5B illustrate comparison of results of simulating the positioning of a moving body, FIG. 5A illustrates the movement of the moving body in a horizontal direction, and FIG. 5B illustrates the movement thereof in the height direction.

FIGS. 6A and 6B illustrate an estimated bias error of an inertial sensor, FIG. 6A illustrates an estimated value of three-axis acceleration bias that is acquired by using a buffering method, and FIG. 6B illustrates an estimated value of three-axis acceleration bias that is acquired by using a propagation method.

### DESCRIPTION OF EXEMPLARY EMBODIMENTS

Hereinafter, an embodiment of the invention will be described with reference to the drawings.

### Moving Body Positioning Apparatus

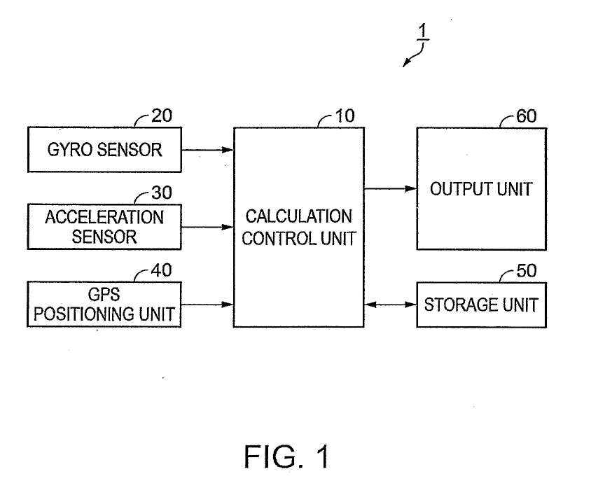

FIG. 1 is a configuration block diagram showing an overview of a moving body control device. The moving body control device 1 includes a gyro sensor 20, an acceleration sensor 30, a GPS (Global Positioning System) positioning unit 40, a calculation control unit 10 that performs a calculation process for positioning data input from the gyro sensor 20, the acceleration sensor 30, and the GPS positioning unit 40, and a storage unit 50 and is connected to an output section 60 of the moving body.

The gyro sensor 20 is arranged in a moving body and detects a turning angular velocity based on a Coriolis force received in accordance with the rotation of a micro vibration plate, for example, by using a quartz crystal vibration sensor or an MEMS (Micro Electro Mechanical Systems) sensor. In this embodiment, a plurality of the gyro sensors 20 is disposed so as to detect a turning angular velocity around each axis and outputs data that represents the tuning angular velocity around each axis.

The acceleration sensor 30 is arranged in a moving body and measures and outputs the acceleration of the moving body in at least one direction. In this embodiment, this acceleration sensor 30 is a quartz crystal vibration sensor or an MEMS sensor and measures and outputs the acceleration of a moving body in each axial direction.

The GPS positioning unit 40 receives signals transmitted from GPS satellites and outputs positioning data that represents the position (latitude, longitude, and altitude). The GPS positioning unit 40 used in this embodiment is widely used, and thus detailed description thereof will not be presented here.

The calculation control unit 10 is configured by a program-controlled device such as a CPU (Central Processing Unit) and operates in accordance with a program that is stored in the storage unit 50. In this embodiment, the calculation control unit 10 performs error estimation and error correction of the position, the velocity, the attitude of a moving body, and the bias of the inertial sensor based on the data output from the gyro sensor 20, the acceleration sensor 30, and the GPS positioning unit 40 and outputs results to the output section 60 of the moving body. The detailed configuration and the operation of the calculation control unit 10 will be described later.

The storage unit 50 is a storage element such as a RAM (Random Access Memory) and maintains a program executed by the calculation control unit 10 therein. In addition, the storage unit 50 operates as a working memory of the calculation control unit 10. The storage unit 50 may be configured to be integrated with the calculation control unit 10.

The output section 60 is configured by a driving device that controls the position, the velocity, and the attitude of a moving body, a display unit used for displaying data in a necessary form, or the like.

Next, the configuration of the calculation control unit 10 will be described.

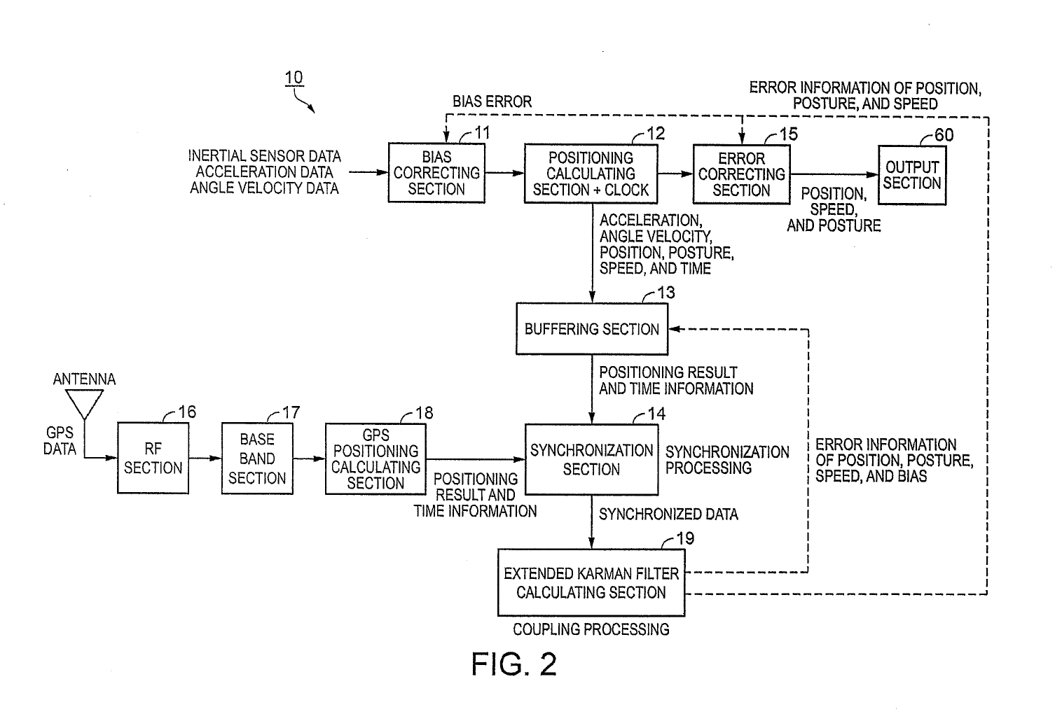

FIG. 2 is a block diagram showing an overview of the calculation control unit. The calculation control unit 10 includes: a bias correcting section 11 that corrects a bias error of detected inertial sensor data (acceleration data and angular velocity data); a positioning calculating section 12 as a unit that calculates a positioning result at the current time by using the inertial sensor data; and an error correcting section 15 that corrects the error of the positioning result of the inertial sensor. To the positioning result calculated by the positioning calculating section 12, time information that represents calculated time is added. In addition, a synchronization section 14 as a unit that performs a synchronization process of the GPS positioning result and the GPS time information and the positioning result and the time information acquired by the inertial sensor, which are stored in a buffering section 13 is further included. The data for which the synchronization process has been performed includes the positioning information of the inertial sensor data and the positioning information of the GPS data, which are synchronized to the time information of the inertial sensor data, and is output to an expanded Karman filter calculating section 19 as a unit that performs a coupling process.

The extended Karman filter calculating section 19 performs a coupling process by using the positioning information of the inertial sensor data and the positioning information of the GPS data, which are synchronized, estimates the error of the positioning result (the position, the attitude, and the velocity) and the bias error (the error of the acceleration bias and the error of the gyro bias) of the inertial sensor by using the expanded Karman filter, performs buffer feedback of the results to the bias correcting section 11 and the buffering section 13, and outputs the results to the error correcting section 15.

The error correcting section 15 as a correction unit corrects the positioning results to the position, the attitude, and the velocity of the inertial sensor at the current time by using the error information of the position, the attitude, and the velocity that is estimated by the extended Karman filter calculating section 19 and outputs the corrected position, the attitude, and the velocity to the output section 60.

Subsequently, the method of positioning a moving body will be described.

### Method of Positioning Moving Body

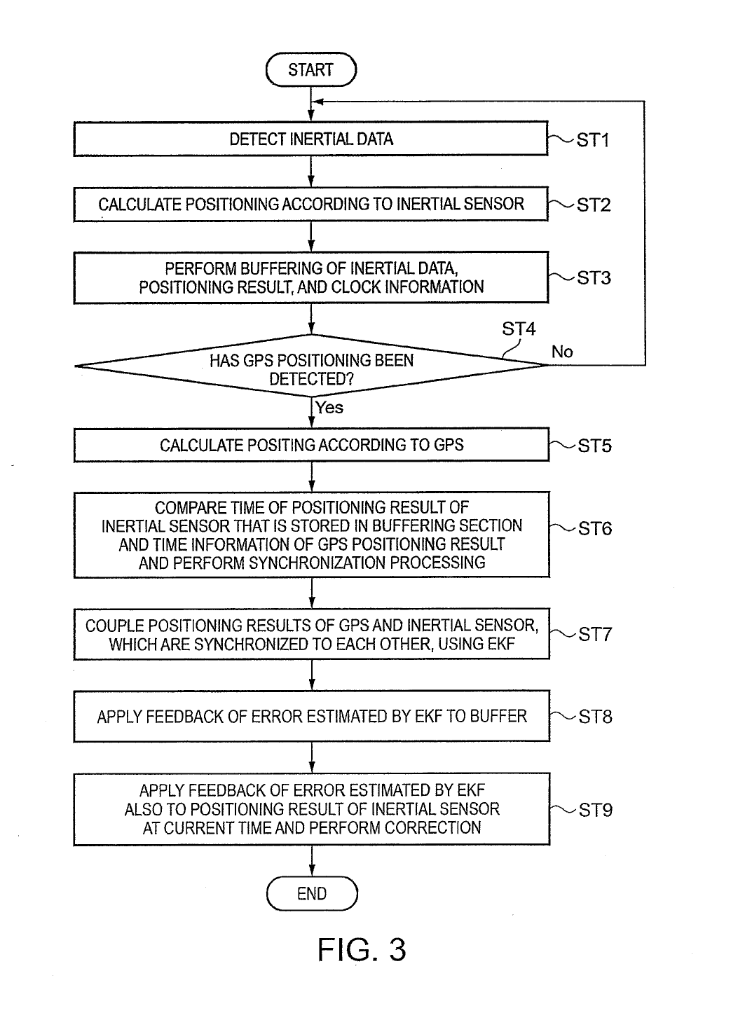

FIG. 3 is a flowchart illustrating the main process of a method of positioning a moving body. The description will be presented also with reference to FIG. 2. First, the acceleration and the angular velocity are detected by using the inertial sensor (ST1), and the calculation of the positioning at the current time of the detection time is performed by the positioning calculating section 12 (ST2). At this time, time information of a clock is added thereto. Next, the detected inertial data and the calculated positioning result, and the time information are buffered in the buffering section 13 (ST3).

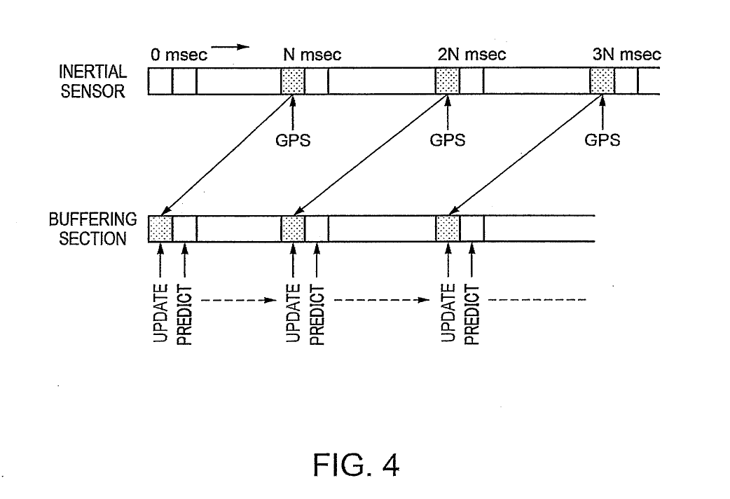

The inertial data is a signal input at 100 Hz (100 times per second=interval of 10 ms) and is detected in approximately real time. The GPS data is a signal input at 1 Hz (once per second=interval of 1000 ms) and can be regarded as a relatively intermittent input signal with respect to the signal of the inertial data. Thus, it is constantly detected whether or not the GPS positioning data has been input (ST4). In the case of no detection (No), the operation of ST1 to ST3 is repeated. On the other hand, in a case where it is determined that there is GPS detection data (Yes), the positioning result of the inertial sensor and the time information, which are buffered in the buffering section 13, and the GPS positioning result and the time information that are based on the GPS data are compared with each other, and a synchronization process is performed by the synchronization section 14 (ST6). A method used for performing the synchronization process will be described with reference to FIG. 4.

FIG. 4 is an explanatory diagram showing the synchronization processing method. The upper portion of the figure illustrates an input signal of the inertial sensor data. Although the inertial sensor data is simplified in the figure, it is a signal of 100 Hz. The GPS data is a signal of 1 Hz, and the GPS positioning result may be delayed by 500 milliseconds to 1 second from the current time due to a transmission delay from the reception of a detection signal at an antenna to the transmission from antenna to a base band section 17 through an RF section 16 and a time required for the process of base band processing, the position calculation, and the like. Thus, in order to calculate a positioning result at the current time by synchronizing the GPS positioning result having a delay and the positioning result of the inertial sensor, a buffering process of the positioning result of the inertial sensor is performed.

Simultaneously with the position calculation performed by the inertial sensor, the inertial sensor data, the positioning result (the acceleration, the angular velocity, the position, the attitude, and the velocity) and the time information of the clock are buffered by the inertial sensor. Then, at a time point when the GPS positioning result is acquired (N milliseconds, 2 N milliseconds, or 3 N milliseconds), the time information (the time when satellite signals are received) of the GPS positioning result and the time information of the positioning result of the inertial sensor that is buffered are compared with each other, and the GPS positioning result and the positioning result of the inertial sensor that have the same time information are output to the expanded Karman filter calculating section 19. For example, when GPS signals are detected at a time point of N milliseconds, the data stored inside the buffering section is updated (denoted by an arrow), and, subsequently, when GPS signals are detected at a time point of 2 N milliseconds, the data stored in the buffering section is updated at the time point of 2 N milliseconds. At this time, the data buffered in advance is removed. A time period between the update at N milliseconds and 2 N milliseconds is an estimation period. Since a period until 2 N milliseconds after the input of the GPS signals at the time point of N milliseconds, no GPS signal is input, during this period, position calculation is performed by using the data updated in accordance with the signal at N milliseconds.

The description will be presented with reference back to FIG. 3.

After the synchronization process (ST6), a coupling process is performed for the GPS positioning result and the positioning result of the inertial sensor that are synchronized to each other by using the expanded Karman filter calculating section (EKF) 19 (ST7). The expanded Karman filter calculating section (EKF) 19 estimates each of the positioning error, the attitude error, the velocity error, and the bias error (a gyro bias error and an acceleration bias error) of the inertial sensor and updates the positioning result of the inertial sensor that is stored in the buffering section 13 (ST8).

In addition, the bias error estimated by the expanded Karman filter calculating section 19 is also fed back to the bias correcting section 11, the information of the position error, the attitude error, and the velocity error are also fed back to the positioning result at the current time of the inertial sensor, and the error correcting section 15 performs error correction of the position error, the attitude error, and the velocity error (ST9) and outputs the results to the display unit or the driving device of the moving body so as to control the moving body.

### Simulation Result

Subsequently, a comparison result between a moving body positioning result of a case where the moving body positioning method according to the above-described embodiment and moving body positioning using a general technique will be described. Here, the moving body positioning method according to this embodiment is configured as the buffering method, the moving body positioning method according to the general technique is configured as the propagation method, and the results are compared with a real value representing the real moving state of the moving body.

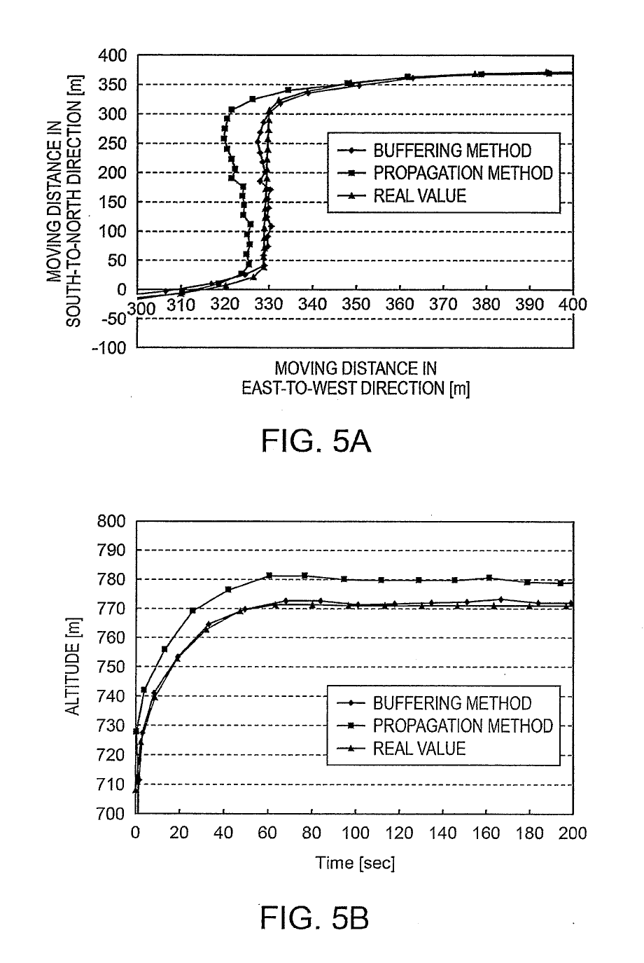

FIGS. 5A and 5B are graphs illustrating the results of simulating the moving body positioning. FIG. 5A illustrates the movement of the moving body in the horizontal direction. Along the horizontal axis, a moving distance [m] in the east-to-west direction is illustrated, and, along the vertical axis, a moving distance [m] in the south-to-north direction is illustrated. In FIG. 5A, as represented by the real value, an example is shown in which the direction is changed toward the northern side when the moving distance of the moving body toward the eastern side is about 330 [m], and the direction is changed again toward the eastern side when the moving distance toward the northern side is about 350 [m]. As shown in FIG. 5A, from a time point when the moving body changes its direction from the movement toward the eastern side to the northern side to a next time point when the moving body changes its direction toward the eastern side, a positioning result close to the real value is acquired according to the buffering method, compared to the propagation method. Since the GPS positioning data and the inertial sensor data are synchronized to each other according to the buffering method, it is apparent that there is an error from the real value in the buffering method which is smaller than that of a case where the propagation method is used.

FIG. 5B illustrates the movement in the height direction. Time (time [sec]) is represented along the horizontal axis, and, the altitude [m] is represented along the vertical axis. As represented by the real value, FIG. 5B shows an example in which a moving body moves to an altitude of 770 [m] for 40 [sec] and thereafter continues to move in the horizontal direction. As shown in FIG. 5B, while a positioning result is acquired according to the propagation method in which an altitude change for each time elapse represents an increase in the altitude at any elapsed time, a positioning result that approximately coincides with the real value is acquired according to the buffering method.

Next, an estimated bias error of the inertial sensor will be described.

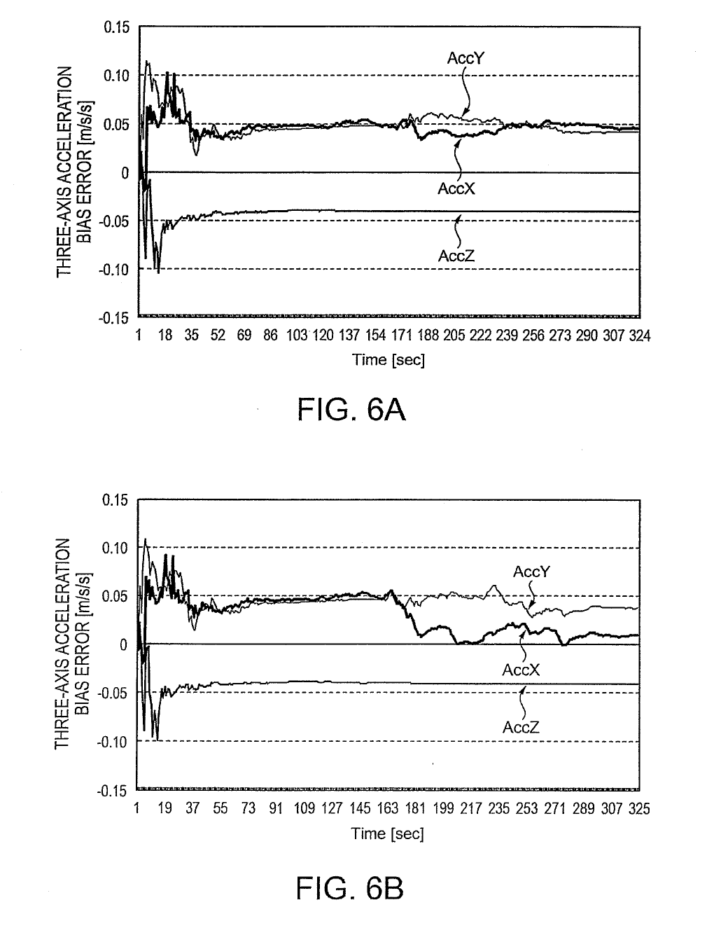

FIGS. 6A and 6B are graphs showing the bias error of the inertial sensor. More specifically, the bias error of the inertial sensor is represented, which is estimated by performing a coupling process for the positioning result synchronized to the current time and the time information by using an expanded Karman filter. A case is illustrated as an example in which a three-axis acceleration sensor is used as the inertial sensor. In the figure, when the horizontal directions are set as the X axis and the Y axis, and the height direction is set as the Z axis, graphs illustrate bias errors of X-direction acceleration (AccX), Y-direction acceleration (AccY), and Z-direction acceleration (AccZ). The horizontal axis represents the elapse time (time [sec]), and the vertical axis is a bias error [m/s/s]. FIG. 6A illustrates estimated values of the three-axis acceleration biases according to the buffering method, and FIG. 6B illustrates estimated values of the three-axis acceleration biases according to the propagation method.

The applied acceleration bias is approximately 0.04 m/s/s for the X axis and the Y axis and is approximately −0.04 m/s/s for the Z axis. Based on the result shown in FIG. 6B, according to the propagation method, the deviated amount of the acceleration bias for the X axis direction increases from time near 170 [sec] due to no synchronization between the GPS positioning data and the positioning data of the inertial sensor. In addition, the position is the position at which the moving body changes its direction, and it is represented that the estimated error of the acceleration bias for the X axis direction increases by changes of the direction. On the other hand, according to the buffering method illustrated in FIG. 6A, since the GPS positioning data and the positioning data of the inertial sensor are synchronized to each other, the estimated error of the acceleration bias is small, and it can be understood that the estimation is correctly made.

As described above, according to the buffering method, simultaneously with the positioning calculation of the inertial sensor, the inertial data and the positioning result are buffered, at a time point when the GPS positioning result is acquired, the time information of the GPS positioning result and the time information of the positioning result of the inertial sensor that is stored in the buffering section 13 are compared with each other, and a synchronization process is performed for the GPS positioning result and the positioning result of the inertial sensor that have the same time information, whereby the position error, the velocity error, the attitude error, and the bias error of the inertial sensor can be correctly estimated.

In addition, error correction is performed through a feedback of the error information acquired by performing a coupling process for the GPS positioning result and the positioning result of the inertial sensor that have the same time information also to the positioning result of the inertial sensor at the current time, whereby more accurate positioning information can be provided in real time.

Furthermore, by using the bias error information of the inertial sensor that is acquired by performing the coupling process for the GPS positioning result and the positioning result of the inertial sensor that have the same time information for the bias correction of the inertial sensor data, more accurate acceleration data and the angular velocity data are acquired, whereby the accuracy of the positioning result can be improved.

In addition, by feeding back the error information acquired by performing the coupling process for the GPS positioning result and the positioning result of the inertial sensor that have the same time information to the buffered positioning result of the inertial sensor, the error in the positioning result can be corrected. Accordingly, at a time point when correct error information is acquired, the past sensor data does not need to be integrated again, whereby the calculation load can be decreased to a large extent.

As the inertial sensor, there is an MEMS sensor that can be decreased in size, weight, and cost and has a large bias error and a random drift. Even in a case where such MEMS sensor is used, according to the buffering method, the positioning of a moving body can be performed with high accuracy.

Furthermore, although in the above-described embodiment, a GPS has been described as an example of the satellite positioning system, it is apparent that another satellite positioning system such as a WAAS (Wide Area Augmentation System), a QZSS (Quasi Zenith Satellite System), a GLONASS (GLObal NAvigation Satellite System), or a GALILEO may be used.

This application claims priority to Japanese Patent Application No. 2011-049917, filed Mar. 8, 2011, the entirety of which is hereby incorporated by reference.

What is claimed is:

1. A positioning apparatus comprising:
a unit that calculates an inertial navigation positioning result by performing position calculation using inertial sensor data and stores the inertial navigation positioning result in a storage unit with time information being added to the inertial navigation positioning result;
a unit that calculates a GPS positioning result by using GPS positioning data;
a unit that performs a coupling process for the GPS positioning result and the inertial navigation positioning result, which is stored in the storage unit, having same time information as time when the GPS positioning data is acquired;
a unit that corrects the inertial navigation positioning result stored in the storage unit based on information of a position error, an attitude error, a velocity error, and a bias error of the inertial sensor that are acquired through the coupling process.

2. The positioning apparatus according to claim 1, wherein the coupling process includes a Karman filter process of the inertial navigation positioning result and the GPS positioning result.

3. The positioning apparatus according to claim 1, wherein an operation of the unit that corrects the inertial navigation positioning result stored in the storage unit includes estimating the positioning error, the attitude error, the velocity error, and the bias error and correcting the inertial navigation positioning result based on the positioning error, the attitude error, the velocity error, and the bias error.

4. The positioning apparatus according to claim 1, wherein the position calculation using the inertial sensor data is performed more frequently than the GPS positioning using the GPS positioning data.

5. The positioning apparatus according to claim 1, wherein the inertial sensor data is data that is measured by at least one of an acceleration sensor and a gyro sensor.

6. A positioning method comprising:
calculating an inertial navigation positioning result by performing position calculation using inertial sensor data and storing the inertial navigation positioning result in a storage unit with time information being added to the inertial navigation positioning result;
calculating a GPS positioning result by using GPS positioning data;
estimating a position error, an attitude error, a velocity error, and a bias error of the inertial sensor by coupling the GPS positioning result and the inertial navigation positioning result, which is stored in the storage unit, having the same time information as time when the GPS positioning data is acquired;
correcting the inertial navigation positioning result stored in the storage unit based on the position error, the attitude error, the velocity error, and the bias error.
